(19) United States
(12) Patent Application Publication
(10) Pub. No.: US 2005/0065297 A1
(43) Pub. Date: Mar. 24, 2005

(54) Radiation curable nail polish

(75) Inventor: Naran Patel, Orange, CA (US)

Correspondence Address: Matthew F. Jodziewicz, Esq., 3447 Mandeville Canyon Road, Los Angeles, CA, 90049, US

(73) Assignee: AMERICAN INTERNATIONAL INDUSTRIES

(21) Appl. No.: 10/664,532

(22) Filed: Sep. 22, 2003

(51) Int. Cl. C08G 59/14

(52) U.S. Cl. 525/532

(57) ABSTRACT

Light cured nail coatings that are applied to natural nails and/or artificial nail-tips for cosmetic purposes are disclosed that eliminate the oxygen inhibited sticky surface layer common for light cured nail coatings, thereby eliminating the need for post application cleansing of the nail surface before polishing.

### BACKGROUND OF THE INVENTION

1. Field of the Invention (Technical Field)

The present invention relates to visible and ultraviolet (“uv”) radiation curable nail (e.g. fingernail and toe nail) coatings that harden quickly and avoid formation of an oxygen inhibited sticky surface layer requiring removal by cleansing with additional chemical application.

2. Background Art

Light curable nail coatings are disclosed in Lilley U.S. Pat. No. 6,599,598, entitled “Radiation Curable Nail Coatings;” Billings, U.S. Pat. No. 5,194,292, entitled “Method of Drying and Bonding Nail Polish;” Cornell, U.S. Pat. No. 4,704,303, entitled “Nail Extension Composition;” and Guiliano, U.S. Pat. No. 4,682,612, entitled “Novel Process and Article for Preparing Artificial Nails.” The '598 patent describes a radiation curable nail polish that includes a uv activated accelerator and initiator for curing in the nail polish. The '292 patent describes a method of protecting common nail polish by applying a light-curable clear coating over the polished nail. The '303 patent describes a coating composition based on an aliphatic or cycloaliphatic hydrocarbon urethane diacrylate or methacrylate having a molecular weight of 250 to 500 and a viscosity of 5,000 to 30,000 cps. Radiation in the visible region is used to cure the '303 patent coatings. The '612 patent describes an organic solvent-free photocurable composition which has at least one liquid monomer in which an acrylated urethane oligomer is dissolved and crosslinked upon cure. Radiation in the uv region is used to cure the '612 patent coatings. None of these patents disclose the use of Bisphenol A Diglycidyl Methacrylate (“BISGMA”) based urethane resin.

Problems associated with the prior light curable nail coatings, such as the '598 patent, include the tendency of the coatings to run on the nail during application. Consequently, the prior art coatings tend to run onto the cuticle or other unwanted areas and cause lifting of the coating with time. In contrast, the present invention comprises a creamy consistency with a viscosity of between approximately 1,000-10,000 cps. The viscosity of the mixtures of the present invention allows the mixtures to be brushed onto the nail or nail tip without significant displacement during the application process, thus reducing the chance of lifting.

Another problem with the prior light curable nail coatings is the use of urethane resins made with high levels of toxic catalysts, which pose a great risk of skin sensitization. In contrast, the urethane resins used in the present invention do not generally cause skin sensitization in the general population.

Another problem with the prior light curable nail coatings is that over time the coatings tend to lift from the natural nail. The present invention overcomes this problem through the optional application of pre-bond compounds that enhance the bond between the natural nail and the coatings of the present invention as well as the prior light curable nail coatings.

Another problem with the prior light curable nail coatings is that upon curing the surface of the coating remains sticky due to air inhibition. Generally, Isoproyl alcohol is then applied to the coating surface to remove the undesirable air inhibited layer. The present invention includes various compounds that cure the surface of the nail coating completely without leaving any layer tacky and hence improve the final appearance and characteristics of the coated nail.

### SUMMARY OF THE INVENTION (DISCLOSURE OF THE INVENTION)

The present invention is of a composition that is applied to natural nails and artificial nail tips. The composition comprises a polymeric compound, a thinner, and a photoinitiator. In one embodiment the composition comprises: between approximately 40 and 90 percent by weight, preferably between approximately 60 to 85 percent by weight, of polymeric compound; between approximately 1 and 25 percent by weight, preferably between approximately 10 and 20 percent by weight, of photoinitiator; and between approximately 1 and 25 percent by weight, preferably between approximately 10 and 15 percent by weight, of a thinner monomer agent. In the preferred embodiment, the polymeric compound or compounds comprise acrylates and/or methacrylates, the photoinitiator comprises phosphinates, phenyl ketones, and phosphine oxides.

In another embodiment the composition may optionally comprise at least one additive such as a plasticizers, colorants, dyes, inhibitors, fillers, fibers, and/or adhesion promoting polymers. The composition preferably comprises between approximately 0 and 50 percent by weight, preferably between approximately 1 and 20 percent by weight, of additive. The composition may optionally comprise: a plasticizer such as phthalates, adipates, and/or sulfonamides; a secondary photoinitiator such as camphorquinone, benzil dimethylketal, and/or benzophenone; a colorant such as barium, calcium, aluminum lakes, iron oxides, talcs, carmine, titanium dioxide, chromium hydroxides, ferric ferrocyanide, ultramarines, titanium dioxide coated mica platelets, and/or bismuth oxychlorides; an inhibitor such as hydroquinone, methyl ether hydroquinone, and/or butylated hydroxy toluene; a filler such as mineral fillers and/or polymeric fillers; and an adhesion promoting polymer such as methacryoyloxy ethyl phthalate.

In another embodiment the composition comprises a BISGMA urethane, a polyether, methacrylated urethane, and a photoinitiator. In one embodiment, the composition comprises: between approximately 30 and 90 percent by weight, preferably between approximately 50 to 70 percent by weight, of BISGMA urethane; between approximately 0.5 to 50 percent by weight, preferably between approximately 10 to 40 percent by weight, of methacrylated urethane; between approximately 10 and 25 percent by weight, preferably between approximately 12 and 20 percent by weight, of photoinitiator. In the preferred embodiment, the composition comprises: a mathacrylated urethane having a viscosity greater than 100,000 cps; a photoinitiator such as d-camphorquinone, ethyl 2,4,6-trimethylbenzoyldiphenylphosphine oxide, benzildimethyl ketal, and/or benzophenone.

In another embodiment the composition may optionally comprise a coupling agent. The composition comprising between approximately 0.01 and 0.5 percent by weight, preferably between approximately 0.05 and 0.15 percent by weight, of coupling agent. In the preferred embodiment, the coupling agent utilized comprises an organo-metallic, preferably an organo-titanate coupling agent such as isopropyldimethylacrylisiostearoyl titanate, tetraisopropyldi(dioctyl)phosphito titanate, neopentyl(diallyl)oxy,tri(dodecyl)benzene-sulfonyl titanate, and neopentyl(diallyl)oxy,trineodecanonyl titanate.

In another embodiment the composition may optionally comprise at least one additive such as a plasticizers, secondary photoinitiators, colorants, dyes, inhibitors, fillers, fibers, and/or adhesion promoting polymers. The composition comprises between approximately 0 and 50 percent by weight, preferably between approximately 1 and 20 percent by weight, of additive. The composition may optionally comprise: a plasticizer such as phthalates, adipates, and/or sulfonamides; a secondary photoinitiator such as d-camphorquinone, benzil dimethylketal, and/or benzophenone; a colorant such as barium, calcium, aluminum lakes, iron oxides, talcs, carmine, titanium dioxide, chromium hydroxides, ferric ferrocyanide, ultramarines, titanium dioxide coated mica platelets, and/or bismuth oxychlorides; an inhibitor such as hydroquinone, methyl ether hydroquinone, and/or butylated hydroxy toluene; a filler such as mineral fillers and/or polymeric fillers; and an adhesion promoting polymer such as methacryoyloxy ethyl phthalate.

A primary object of the present invention is to provide hard and durable coatings for the cosmetic industry, particularly for the cosmetic nail industry.

A further object of the invention is to provide high gloss and smooth finishing compounds that are applied to the coated fingernails after curing.

A further object of the invention is to provide pre-bonding compounds that are applied to the natural nail to enhance bonding between the nail coatings and the natural nail.

A primary advantage of the present invention is that the coating compounds are of sufficient viscosity such that the compounds do not tend to run off the nail and onto the finger or toe.

Another advantage of the present invention is that the coating compounds result in a strong and durable bond to both artificial nail tips and natural nails.

Another advantage of the present invention is that the coating compounds comprise chemical compounds that exhibit a low degree of skin sensitivity.

Another advantage of the present invention is that a pre-bonding compound may be used in conjunction with the coating compounds.

Another advantage of the present invention is that the coating compounds embodying the present invention result in a strong and durable coating to both artificial nail tips and natural nails that do not create an oxygen inhibited surface layer while drying requiring removal or cleansing with additional chemicals.

Another advantage of the present invention is that a finishing compound may be used in conjunction with the coating compounds to clean the surface of the coating and apply a polished, high gloss surface.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the appended claims.

### DESCRIPTION OF THE PREFERRED EMBODIMENTS (BEST MODES FOR CARRYING OUT THE INVENTION)

The present invention relates to actinic (visible and uv) radiation curable coating compositions used to coat artificial nail tips and strengthen and coat natural nails. The compositions are applied to the natural nail or to the natural nail and a pre-formed nail tip that is attached to the natural nail. The coatings react with actinic radiation, even in highly colored compositions. The coating compositions can be formulated in clear, opaque white, translucent colors and opaque colors, and cure, in some cases, in less than two minutes with uv radiation. The coating compounds are either polymeric or urethane based. In the case of the polymeric compounds the term “polymeric” or “polymer” as used throughout the specification and claims, is intended to include monomers, oligomers, and polymers.

In one embodiment of the invention, a biocompatible solvent-based adhesive resin (pre-bond compound) is used to enhance the bond between the radiation curable nail coatings and the natural nail. The natural nails are preferably prepared by filing, and a thin coat of the solvent-based adhesive resin is applied to the surface of the natural nail beginning at the cuticle area. The solvent evaporates leaving a sticky layer of the adhesive. The radiation curable nail coating is then applied to the adhesive. In another embodiment incorporating artificial nail tips, the artificial nail tip is attached to the natural nail as is known in the art. A thin coat of the solvent-based adhesive resin is applied to the surface of the natural nail beginning at the cuticle area and ending at the front edge of the nail tip. There is no need to apply the adhesive resin to the surface of the nail tip. The solvent evaporates leaving a sticky layer of the adhesive. The radiation curable nail coating is then applied to the adhesive on the surface of the natural nail as well as the nail tip. The use of the adhesive resin enhancer prevents lifting of the cured coating from the natural nail, adding longevity and beauty.

Pre-bond Compounds

The present invention includes the use of pre-bond compounds that are applied to the natural nail to enhance the adhesive properties of the coating compounds of the invention. The pre-bond compounds generally comprise an acrylate based polymer, preferably an aromatic acid methacrylate, in a biocompatible solvent. The solvent in the composition is biocompatible and evaporates rapidly after being applied to the natural nail. It may be a single organic solvent or blend of organic solvents. The solvent is preferably selected from the group consisting of alcohols, ketones and esters. In the preferred embodiment, the biocompatible solvent is acetone and comprises between approximately 50-95% by weight and preferably between approximately 60-80% by weight, of the composition.

The pre-bond compounds are used in conjunction with the coatings of the present invention to greatly enhance the bonding of the coatings to the natural nail. As a result, lifting of the coating at the cuticle area is significantly reduced.

Coating Compounds

The present invention relates to actinic radiation, preferably uv radiation, curable compounds used to coat natural nails and pre-formed artificial nail tips. The nail tips are attached to the natural nail with a known cyanoacrylate gel compound (e.g. see Cornell U.S. Pat. No. 4,704,303). The coatings of the present invention are durable and do not result in skin sensitivity in the majority of the population. In the preferred embodiment, the coating compounds comprise: (a) an acrylated oligomer polymer such as an epoxy acrylated oligomer; (b) a photoinitiator, preferably a phosphinate or phosphine oxide photoinitiator; and (c) a thinner, preferably an acrylic ester monomer such as triethyleneglycol divinylether. The coating compounds may further comprise a coupling agent, preferably, a titanate coupling agent, and various other additives such as plasticizers, other photoinitiators, colorants, dyes, inhibitors, fillers, fibers, and adhesion promoting monomers.

In one embodiment, the composition preferably comprises: 1) between approximately 40-90% by weight and preferably between approximately 60-85% by weight of component (A); 2) between approximately 10-25% by weight and preferably between approximately 10-20% by weight of component (B); and 3) between approximately 10-25% by weight and preferably between approximately 10-15% by weight of component (C). The one embodiment may further comprise between approximately 0.01-0.5% by weight and preferably between approximately 0.05-0.15% by weight of a coupling agent (component (D)); and between approximately 0-50% by weight and preferably between approximately 1-20% by weight of other additives (component (E)).

Component (A) is preferably acrylated or methacrylated polymer such as an epoxy acrylated oligomer. Component (B) is preferably a phenyl ketone photoaccelerator, such as hydroxycyelohexyl phenyl ketone or an aliphatic or aromatic amine photoaccelerator such as ethyl 4-dimethylamino benzoate, butoxyethyl dimethylaminobenzoate, octyl-para-dimethylaminobenzoate or ethyl dimethyl aminoethyl methacrylate. Component (C) is a thinner monomer, preferably an acrylic ester monomer such as triethyleneglycol divinylether. The preferred coupling agent, component (D), is an organic titanate coupling agent such as a class of neoalkoxy titanates. Additional and optional additives, component (E), may include: plasticizers such as the phthalates, adipates and sulfonamides; other photoinitiators such as camphorquinone and benzil dimethylketal, benzophenone; inhibitors such as hydroquinone, methyl ether hydroquinone and butylated hydroxy toluene; mineral and polymeric fillers; fibers; adhesion promoting monomers such as methacryoyloxy ethyl phthalate; and colorants such as barium, calcium and aluminum lakes, iron oxides, talcs, carmine, titanium dioxide, chromium hydroxides, ferric ferrocyanide, ultramarines, titanium dioxide coated mica platelets and bismuth oxychlorides.

In a second embodiment, the coating composition is based on the combination of a BISGMA urethane and an aliphatic methacrylated urethane with a preferred viscosity greater than 100,000 cps. The BISGMA based nail coating, even a coating that is heavily pigmented, reacts with uv radiation. A coat of the material cures with a standard ultraviolet nail light in less than two minutes. Moreover, it cures with visible light, such as from a dental curing unit, in less than 20 seconds.

Another embodiment of the present invention preferably comprises: 1) a resin, preferably a BISGMA urethane resin, prepared from an adduct of BISGMA and an aliphatic or cycloaliphatic hydrocarbon diisocyanate (component (A)); 2) a polyether based, methacrylated aliphatic urethane oligomer with a viscosity greater than 80,000 cps (component (B)); 3) a photoinitiator (component (C)); and 4) a photoaccelerator (component (D)). This second embodiment may further comprise a coupling agent (component (E)) and various other additives such as plasticizers, colorants, dyes, inhibitors, fillers, fibers, adhesion promoting monomers and crosslinking monomers (components (F)). The coating preferably comprises between approximately 30-90% by weight of and preferably between approximately 50-70% by weight of component (A); between approximately 0.5-50% by weight and preferably between approximately 10-40% by weight of component (B); between approximately 0.05-10% by weight and preferably between approximately 0.5-5% by weight of component (C); and between approximately 0.1-5% by weight and preferably between approximately 0.25-1% by weight of component (D). The coating may further comprise a coupling agent (component (E)) in an amount of between approximately 0.01-0.5% by weight and preferably between approximately 0.05-0.15% by weight. Further, the composition may optionally comprise between approximately 1-50% and preferably between approximately 5-20% by weight of any one or combination of components (F).

The BISGMA based urethane resin is preferably prepared by reacting the hydroxyl functions of BISGMA with a hydrocarbon diisocyanate. In the preferred embodiment, the BISGMA is diluted with dimethacrylate monomers, a catalyst is added and then the diisocyanate compound is slowly added. The reaction mixture is heated (approximately 55 .degree. C.) until all the diisocyanate has reacted to the BISGMA urethane. BISGMA can be purchased from Esstech, and is also sold as Nupol 46-4005 from Cook Composites and Polymers. BISGMA is a very thick, sticky, liquid that must be diluted with dimethacrylate monomers prior to the addition of the diisocynate. The dimethacrylate monomers are well suited for the dilution step because they exhibit relatively low volatility and low odor. The dimethacrylate monomers also serve as crosslinking agents in the urethane resin. Suitable dimethacrylate monomers are diethylene glycol dimethacrylate, 1,6-hexane diol dimethacrylate, triethylene glycol dimethacrylate, ethoxylated bisphenol A dimethacrylate, polyethylene glycol dimethacrylate, and 1,4-butanediol dimethacrylate. The final urethane resin comprises between approximately 30-70% dimethacrylate monomers based on the weight of the BISGMA adduct in the urethane resin.

Urethane catalysts useful in the invention are tin compounds such as dibutyl tin dilaureate and stannous octoate. They are used at levels between approximately 0.005-0.10% by weight in the urethane resin. The tin compound is added to the mixture of BISGMA and dimethacrylate monomers and mixed. The diisocyanate is an aliphatic or cycloaliphatic hydrocarbon such as heptyl diisocyanate, trimethylhexamethylene diisocyanate, or isophorone diisocyanate. The diisocyanate is slowly added to the BISGMA, dimethacrylate monomer and catalyst mixture to form the urethane. The diisocyanate is used at levels of between approximately 5-12% by weight of the urethane resin. Alternatively, the diisocynate may be diluted with dimethacrylate monomer to control the exothermic urethane reaction. Once the urethane reaction is completed, a small amount of inhibitor, preferably butylated hydroxy toluene, in an amount of between approximately 0.01-0.10% by weight, is added.

The polyether based methacrylated aliphatic urethane oligomer with a viscosity greater than 80,000 cps is then mixed with the BISGMA based urethane. The photoinitiator is then added, preferably camphorquinone, ethyl 2,4,6-trimethylbenzoylphenylphosphinate, 2,4,6-trimethylbenzoyl diphenylphosphine oxide, benzil dimethyl ketal and/or benzophenone. The remaining ingredients are also added: plasticizers such as phthalates, adipates, and sulfonamides; aliphatic or aromatic amine photoaccelerators such as ethyl 4-dimethylaminobenzoate, butoxyethyl dimethylaminobenzoate, octyl-para-dimethylaminobenzoate, and ethyl dimethylaminoethyl methacrylate; titanate coupling agents such as isopropyl dimethacryl isostearoyl titanate, tetraisopropyl di(dioctyl)phosphito titanate, neopentyl(diallyl)oxy-tri(dodecyl)benzene-sulfonyl titanate, and neopentyl(diallyl)oxy-trineodecanonyl titanate; inhibitors such as hydroquinone, methyl ether hydroquinone and butylated hydroxy toluene; mineral and polymeric fillers; fibers; adhesion promoting monomers such as methacryoyloxy ethyl phthalate; colorants such as barium, calcium, aluminum lakes, iron oxides, talcs, carmine, titanium dioxide, chromium hydroxides, ferric ferrocyanide, ultramarines, titanium dioxide coated mica platelets, and bismuth oxychlorides.

Finishing Compounds

The present invention comprises nail finishing compounds that complement the actinic radiation curable coatings. After the coating has been applied and cured with actinic radiation, oxygen inhibition causes the surface of the coating to become tacky. Typically, isopropyl alcohol is used to remove the sticky layer. As an alternative, the compositions of the finishing compounds may be applied with a cotton swab or pad, or sprayed directly onto the nail to remove the sticky surface. The nail is then rubbed, for example, with a clean cloth, resulting in a clean smooth surface. A high gloss surface results using the finishing compounds of the present invention as compared to using 100% isopropyl alcohol. The nail treatment may be considered complete at this point. If higher gloss is desired, a topcoat of a solvent-based cellulose material may be applied to complete the procedure.

Method of Applying Compounds to Natural Nails and Nail-tips

It is preferred that before applying the compounds of the present invention to a natural nail, the nail be cleaned and roughened by filing the top surface of the nail to remove oils and create a surface for bonding. An artificial nail tip attached to a natural nail may not need the surface preparation of a natural nail, but cleansing and roughening of the surface will aid in bonding of the nail polish to the artificial nail tip as well as to the natural nail. A bond-enhancing compound may then be applied to the surface of the nail that is to be coated. If such a bond-enhancing compound is first applied, the compound must be allowed to dry or evaporate, leaving a tacky surface ready for the nail polish itself.

The compounds of the present invention are then applied to the cleaned and roughened prepared nail and the coated nail exposed to ultraviolet radiation to cure the coating polish. If additional coatings are to be applied to the nail surface, each one should be delayed until the previous coating has dried.

The method of applying the colored coating compounds is similar to the methods described above for the clear-white tipped nails except the second final clear coat is replaced with a colored coating. Application of an optional second colored coat is applied for best results.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A radiation curable natural nail and/or artificial nail tip coating composition comprising:
a polymer;
a monomer; and
a photoinitiator wherein said photoinitiator comprises hydroxycyelohexyl phenyl ketone;
said composition of a sufficient viscosity to be applied to natural nails and artificial nail tips and so as to not run on the nail or nail tip during application.

2. The composition of claim 1 wherein said polymer comprises at least one member selected from the group of acrylates and methacrylates.

3. The composition of claim 2 wherein said polymer comprises an epoxy acrylated oligomer.

4. The composition of claim 1 wherein said monomer comprises at least one member selected from the group of acrylic ester monomers.

5. The composition of claim 4 wherein said monomer comprises triethyleneglycol dimethacrylate.

6. A radiation curable natural nail and/or artificial nail tip coating composition comprising:
a polymer having at least one member selected from the group of acrylates and methacrylates, and wherein said polymer comprises between 40-90% by weight and preferably between approximately 60-85% by weight of the composition; a monomer; and
a photoinitiator wherein said photoinitiator comprises hydroxycyelohexyl phenyl ketone;
said composition of a sufficient viscosity to be applied to natural nails and artificial nail tips and so as to not run on the nail or nail tip during application.

7. The composition of claim 6 wherein said polymer comprises an epoxy acrylated oligomer.

8. The composition of claim 6 wherein said monomer comprises at least one member selected from the group of acrylic ester monomers.

9. The composition of claim 8 wherein said monomer comprises triethyleneglycol dimethacrylate and vinylether.

10. A radiation curable natural nail and/or artificial nail tip coating composition comprising:
a polymer;
a monomer having at least one member selected from the group of acrylic ester monomers, and between approximately 1-25% by weight and preferably between approximately 10-15% by weight of the composition; and
a photoinitiator wherein said photoinitiator comprises hydroxycyelohexyl phenyl ketone;
said composition of a sufficient viscosity to be applied to natural nails and artificial nail tips and so as to not run on the nail or nail tip during application.

11. The composition of claim 10 wherein said polymer comprises at least one member selected from the group of acrylates and methacrylates.

12. The composition of claim 11 wherein said polymer comprises an epoxy acrylated oligomer.

13. The composition of claim 10 wherein said monomer comprises triethyleneglycol dimetheracrylate and vinylether.

14. A radiation curable natural nail and/or artificial nail tip coating composition comprising:
a polymer;
a monomer; and
a photoinitiator wherein said photoinitiator comprises hydroxycyelohexyl phenyl ketone, and comprises between approximately 1-25% by weight and preferably between approximately 10-20% by weight of the composition;
said composition of a sufficient viscosity to be applied to natural nails and artificial nail tips and so as to not run on the nail or nail tip during application.

15. The composition of claim 14 wherein said polymer comprises at least one member selected from the group of acrylates and methacrylates.

16. The composition of claim 15 wherein said polymer comprises an epoxy acrylated oligomer.

17. The composition of claim 14 wherein said monomer comprises at least one member selected from the group of acrylic ester monomers.

18. The composition of claim 17 wherein said monomer comprises triethyleneglycol dimethacrylate and vinylether.

19. A radiation curable natural nail and/or artificial nail tip coating composition comprising:
a polymer having at least one member selected from the group of acrylates and methacrylates, and wherein said polymer comprises between 40-90% by weight and preferably between approximately 60-85% by weight of the composition;
a monomer having at least one member selected from the group of acrylic ester monomers, and between approximately 1-25% by weight and preferably between approximately 10-15% by weight of the composition; and
a photoinitiator wherein said photoinitiator comprises hydroxycyelohexyl phenyl ketone, and comprises between approximately 1-25% by weight and preferably between approximately 10-20% by weight of the composition;
said composition of a sufficient viscosity to be applied to natural nails and artificial nail tips and so as to not run on the nail or nail tip during application.

20. The composition of claim 19 wherein said polymer comprises an epoxy acrylated oligomer.

21. The composition of claim 19 wherein said monomer comprises triethyleneglycol dimethacrylate and vinylether.
